(19) United States
(12) Patent Application Publication
(10) Pub. No.: US 2024/0361624 A1
(43) Pub. Date: Oct. 31, 2024

(54) OPTICAL MODULATOR

(71) Applicant: Murata Manufacturing Co., Ltd., Nagaokakyo-shi (JP)

(72) Inventors: Satoki HAMAMURA, Nagaokakyo-shi (JP); Yasuhiro AIDA, Nagaokakyo-shi (JP)

(21) Appl. No.: 18/768,275

(22) Filed: Jul. 10, 2024

Related U.S. Application Data
(63) Continuation of application No. PCT/JP2023/022845, filed on Jun. 21, 2023.

(30) Foreign Application Priority Data
Nov. 30, 2022 (JP) 2022-192105

(51) Int. Cl. G02F 1/035

(52) U.S. Cl. CPC G02F 1/035; G02F 2201/063; G02F 2202/06; G02F 2202/42

(57) ABSTRACT

An optical modulator includes an optical waveguide, a first electrode, a second electrode, and a first low dielectric constant layer. The optical waveguide includes a material having an electro-optic effect. The first electrode includes a semiconductor material and is spaced by a gap from the optical waveguide. The second electrode is positioned to provide a potential difference with the first electrode and apply an electric field to the optical waveguide. The first low dielectric constant layer has a refractive index smaller than that of the optical waveguide, and is provided in the gap between the first electrode and the optical waveguide.

### CROSS REFERENCE TO RELATED APPLICATIONS

This application claims the benefit of priority to Japanese Patent Application No. 2022-192105 filed on Nov. 30, 2022 and is a Continuation Application of PCT Application No. PCT/JP2023/022845 filed on Jun. 21, 2023. The entire contents of each application are hereby incorporated herein by reference.

### BACKGROUND OF THE INVENTION

### 1. Field of the Invention

The present disclosure relates to optical modulators.

### 2. Description of the Related Art

With the spread of mobile terminals and cloud, Internet traffic is increasing significantly. This has resulted in an expanding demand for optical communications. The optical communications require optical transceivers to mutually convert optical signals and electrical signals. The optical transceiver includes an optical modulator as its main component. The optical modulator functions to convert electrical signals into optical signals.

An optical modulator of the related art is described in Japanese Unexamined Patent Application Publication No. 2020-034610, for example. The optical modulator of Japanese Unexamined Patent Application Publication No. 2020-034610 includes a core part having a slot waveguide structure. The core part includes an upper high refractive index layer, a lower high refractive index layer, and a low refractive index layer provided in a gap (slot) between these high refractive index layers. The refractive index of the upper and lower high refractive index layers is higher than the refractive index of the low refractive index layer. The upper and lower high refractive index layers each have a contact region. A metal electrode is connected to each of the contact regions.

### SUMMARY OF THE INVENTION

As described in Japanese Unexamined Patent Application Publication No. 2020-034610, the metal electrode is used in the optical modulator of the related art. As the material for the electrodes of the optical modulator, materials other than metal materials are not usually selected. When the electrode is made of a material other than the metal material, light may be easily absorbed by the electrode depending on the material. When light is absorbed by the electrodes, the loss of light increases.

Example embodiments of the present invention provide optical modulators that each can reduce or prevent loss of light while realizing the application of materials other than metal materials included in electrodes.

An optical modulator according to the present disclosure includes an optical waveguide, a first electrode, a second electrode, and a first low dielectric constant layer. The optical waveguide includes a material having an electro-optic effect. The first electrode includes a semiconductor material and is spaced by a gap from the optical waveguide. The second electrode is positioned to apply an electric field to the optical waveguide by providing a potential difference with the first electrode. The first low dielectric constant layer has a refractive index smaller than that of the optical waveguide, and is provided in the gap between the first electrode and the optical waveguide.

The optical modulators according to example embodiments of the present disclosure can each reduce or prevent loss of light while realizing the application of materials other than metal materials included in electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view showing a schematic configuration of an optical modulator according to a first example embodiment of the present invention.

FIG. 2 is a graph showing the correlation between the ratio t2/t4 of a thickness t2 of a first electrode to a thickness t4 of a first low dielectric constant layer and the ratio Z/Z0 of a resistance Z of the optical modulator to a termination resistance Z0 according to the first example embodiment of the present invention.

FIG. 3 is a diagram showing modification 1 of the optical modulator according to the first example embodiment of the present invention.

FIG. 4 is a diagram showing modification 2 of the optical modulator according to the first example embodiment of the present invention.

FIG. 5 is a cross-sectional view showing a schematic configuration of an optical modulator according to a second example embodiment of the present invention.

FIG. 6 is a graph showing the correlation between the ratio t2A/t4A of a thickness t2A of a first electrode to a thickness t4A of a first low dielectric constant layer and the ratio Z/Z0 of a resistance Z of the optical modulator to a termination resistance Z0 according to the second example embodiment of the present invention.

FIG. 7 is a graph showing the correlation between the ratio t1Ab/t4A of a thickness t1Ab of an optical waveguide to the thickness t4A of the first low dielectric constant layer and an effective refractive index n according to the second example embodiment of the present invention.

FIG. 8 is a cross-sectional view showing a schematic configuration of an optical modulator according to a third example embodiment of the present invention.

FIG. 9 is a cross-sectional view showing a schematic configuration of an optical modulator according to a fourth example embodiment of the present invention.

FIG. 10 is a diagram showing a modification of the optical modulator according to the fourth example embodiment of the present invention.

### DETAILED DESCRIPTION OF EXAMPLE THE EMBODIMENTS

Example embodiments of the present disclosure will be described below. Note that in the following description, the example embodiments of the present disclosure will be described using examples, but the present disclosure is not limited to the examples described below. Although specific numerical values and specific materials may be illustrated in the following description, the present disclosure is not limited to those examples.

An optical modulator according to an example embodiment of the present disclosure includes an optical waveguide, a first electrode, a second electrode, and a first low dielectric constant layer. The optical waveguide includes a material having an electro-optic effect. The first electrode includes a semiconductor material and is spaced by a gap from the optical waveguide. The second electrode is positioned to apply an electric field to the optical waveguide by providing a potential difference with the first electrode. The first low dielectric constant layer has a refractive index smaller than that of the optical waveguide, and is provided in the gap between the first electrode and the optical waveguide (first configuration).

In the first configuration, the first electrode, of the first electrode and second electrode that apply an electric field to the optical waveguide, is made of a semiconductor material. The semiconductor material is typically doped with impurities. To improve the function of the first electrode as an electrode, the impurity doping amount needs to be increased. As the impurity doping amount increases, conductivity of the first electrode increases, but light absorptivity of the first electrode also increases. The first electrode made of the semiconductor material also has a refractive index larger than that of the optical waveguide. For this reason, when the first electrode is in contact with the optical waveguide, light easily leaks from the optical waveguide to the first electrode. Therefore, in the first configuration, the first electrode is spaced by a gap from the optical waveguide so as not to be in contact with the optical waveguide, and the first low dielectric constant layer having a refractive index smaller than that of the optical waveguide is disposed in the gap between the first electrode and the optical waveguide. This prevents the light passing through the optical waveguide from leaking to the first electrode side and from being absorbed by the first electrode. This makes it possible to reduce or prevent the loss of light while realizing the application of a semiconductor material other than a metal material to the first electrode.

The optical modulator having the first configuration may further include a second low dielectric constant layer. The second low dielectric constant layer has a refractive index smaller than that of the optical waveguide. In this case, the second electrode is spaced by a gap from the optical waveguide, and the second low dielectric constant layer is provided in the gap between the second electrode and the optical waveguide (second configuration).

In the second configuration, the second electrode, of the first electrode and second electrode that apply an electric field to the optical waveguide, is spaced by a gap from the optical waveguide. Therefore, the second electrode is not in contact with the optical waveguide. The second low dielectric constant layer having a refractive index lower than that of the optical waveguide is provided in the gap between the second electrode and the optical waveguide. This prevents the light passing through the optical waveguide from leaking to the second electrode side and from being absorbed by the second electrode. Therefore, the loss of light can be further reduced or prevented.

In the optical modulator having the first configuration, the first low dielectric constant layer may surround the optical waveguide when viewed in a cross section perpendicular to an extending direction of the optical waveguide, and may be provided between the optical waveguide and each of the first electrode and the second electrode (third configuration).

In the optical modulator having any one of the first to third configurations, it is preferable that the first electrode is stacked on the optical waveguide and the second electrode is stacked on the optical waveguide on the opposite side of the first electrode (fourth configuration). In this case, the optical waveguide is provided between the first electrode and the second electrode in the stacking direction of the first electrode, the optical waveguide, and the second electrode. Therefore, the electric field can be efficiently applied to the optical waveguide by the first electrode and the second electrode.

In the optical modulator having the fourth configuration, the ratio of the thickness of the first electrode to the thickness of the first low dielectric constant layer is preferably about 20.0 or more and about 44.0 or less, for example (fifth configuration). This can reduce or prevent the generation of reflected waves of electrical signals.

In the optical modulator having the first configuration, the optical waveguide includes a substrate and a ridge protruding from the surface of the substrate. The first low dielectric constant layer may be stacked on the substrate and the ridge, and the first electrode and the second electrode may be stacked on the first low dielectric constant layer and parallel or substantially parallel with a gap therebetween (sixth configuration).

In the optical modulator having the sixth configuration, the ratio of the thickness of the first electrode to the thickness of the first low dielectric constant layer at the position of the ridge is preferably about 0.1 or more and about 4.0 or less, for example (seventh configuration). This can reduce or prevent the generation of reflected waves of electrical signals.

In the optical modulator having any one of the first to seventh configurations, the size of the gap between the first electrode and the optical waveguide is preferably about 0.750 μm or more and about 1.675 μm or less, for example (eighth configuration).

Weak light seeps out from the optical waveguide into the first low dielectric constant layer provided in the gap between the first electrode and the optical waveguide. This seeping light is called evanescent light. As in the eighth configuration, if the size of the gap between the first electrode and the optical waveguide is about 0.750 μm or more, for example, the evanescent light becomes less likely to come into contact with the first electrode. This can further reduce or prevent the loss of light.

In the eighth configuration, the size of the gap between the first electrode and the optical waveguide is about 1.675 μm or less, for example. In this case, the distance between the first electrode and the optical waveguide does not increase too much, and the magnitude of the electric field to the optical waveguide can be ensured without increasing the voltage applied between the first electrode and the second electrode.

In the optical modulator having any one of the first to eighth configurations, the semiconductor material of the first electrode is preferably a silicon semiconductor material in which silicon is doped with an impurity (ninth configuration).

In the optical modulator having the ninth configuration, the impurity concentration of the first electrode is preferably about 1.0×10¹⁷ cm⁻³ or more and about 1.0×10²² cm⁻³ or less, for example (tenth configuration). In the first electrode, the resistivity decreases and the conductivity increases as the impurities increase. When the impurity concentration is about 1.0×10¹⁷ cm⁻³ or more, for example, the first electrode can effectively function as an electrode. With the impurity concentration of about 1.0×10²² cm⁻³ or less, for example, impurity precipitation can be prevented.

In the optical modulator having the ninth or tenth configuration, the first electrode is preferably a silicon single crystal substrate (eleventh configuration).

In the optical modulator having any one of the ninth to eleventh configurations, the main component of the first low dielectric constant layer may be SiO₂ (twelfth configuration). The semiconductor material used for the first electrode is a silicon semiconductor material. Thus, the first low dielectric constant layer of SiO₂ can be formed on the first electrode by a thermal oxidation method. The film formation with the thermal oxidation method achieves good close contact of the first low dielectric constant layer with the first electrode, thus preventing foreign matter from entering the interface between the first electrode and the first low dielectric constant layer. This can reduce or prevent electrical loss at the interface between the first electrode and the first low dielectric constant layer. The accumulation of foreign matter is also reduced or prevented at the interface between the first electrode and the first low dielectric constant layer, and thus the reliability and life of the optical modulator can be improved.

In the optical modulator having any one of the first to twelfth configurations, the refractive index of the first electrode is smaller than 3 (thirteenth configuration). In this case, the refractive index of the first electrode becomes smaller than 3, corresponding to the impurity concentration (doping amount) of the tenth configuration, for example.

In the optical modulator having any one of the first to thirteenth configurations, the surface layer of the first electrode on the optical waveguide side is preferably doped with an impurity at a higher concentration than other portions of the first electrode (fourteenth configuration). In this case, a region with high conductivity can be localized near the optical waveguide in the first electrode, and a skin effect can reduce or prevent attenuation of high-frequency signals.

Hereinafter, example embodiments of the present disclosure will be described with reference to the drawings. In the drawings, the same or equivalent components are denoted by the same reference numerals, and overlapping description will not be repeated.

### First Example Embodiment

### Configuration of Optical Modulator

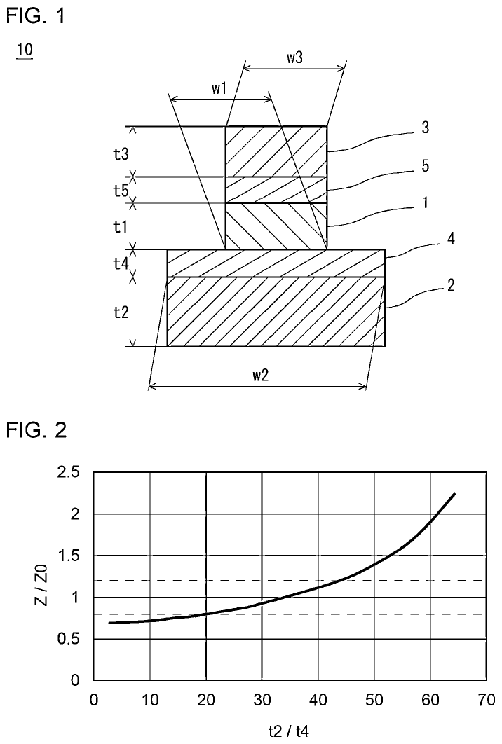

FIG. 1 is a cross-sectional view showing a schematic configuration of an optical modulator 10 according to a first example embodiment. The optical modulator 10 includes an optical waveguide 1, a first electrode 2, a second electrode 3, a first low dielectric constant layer 4, and a second low dielectric constant layer 5. FIG. 1 shows a cross section perpendicular to an extending direction of the optical waveguide 1. In this specification, unless otherwise specified, the term “cross section” means a cross section perpendicular to the extending direction of the optical waveguide 1.

As shown in FIG. 1, the optical waveguide 1 may have a substantially rectangular cross section. The optical waveguide 1 is made of a material having an electro-optic effect (electro-optic material). The optical waveguide 1 functions as a light transmission path. As the optical waveguide 1, LiNbO₃ (lithium niobate), LiTaO₃ (lithium tantalate), PLZT (lead lanthanum zirconate titanate), KTN (potassium tantalate niobate), BaTiO₃ (barium titanate) or the like is used. As the optical waveguide 1, an electro-optic polymer (EO polymer) may be used.

The first electrode 2 and the second electrode 3 function as control electrodes to control light passing through the optical waveguide 1. The first electrode 2 and the second electrode 3 may each have a rectangular or substantially rectangular cross section. The first electrode 2 and the second electrode 3 are positioned to provide a potential difference therebetween and apply an electric field to the optical waveguide 1. The optical waveguide 1 is disposed between the first electrode 2 and the second electrode 3.

In the example of this example embodiment, the first electrode 2 is stacked on the optical waveguide 1. The second electrode 3 is stacked on the optical waveguide 1 on the opposite side of the first electrode 2. From another point of view, the first electrode 2 and the second electrode 3 are disposed so as to sandwich the optical waveguide 1.

The first electrode 2 is spaced by a gap from the optical waveguide 1. In this example embodiment, the first electrode 2 is separated from the optical waveguide 1 in the stacking direction of the optical waveguide 1 and the electrodes 2 and 3. The first electrode 2 is not in contact with the optical waveguide 1. The size of the gap between the first electrode 2 and the optical waveguide 1 is, for example, about 0.750 μm or more and about 1.675 μm or less. In this specification, the size of the gap between the first electrode 2 and the optical waveguide 1 means the shortest distance from the first electrode 2 to the optical waveguide 1. In the case of this example embodiment, the distance from the first electrode 2 to the optical waveguide 1 in the stacking direction is the shortest distance from the first electrode 2 to the optical waveguide 1.

The first electrode 2 is made of a semiconductor material. Specifically, the first electrode 2 is a semiconductor electrode. The semiconductor material used for the first electrode 2 is typically a silicon semiconductor material in which silicon (Si) is doped with an impurity. As the semiconductor material, another single-element semiconductor using germanium (Ge) or a compound semiconductor such as gallium arsenide (GaAs) may be used, for example. The impurity may be either a p-type impurity or an n-type impurity. For example, when the semiconductor material is a silicon semiconductor material, a Group 3 element such as boron is used as the p-type impurity, and a Group 5 element such as phosphorus, arsenic, or antimony is used as the n-type impurity.

When the semiconductor material used for the first electrode 2 is a silicon semiconductor material, the impurity concentration (doping amount) of the first electrode 2 is preferably about 1.0×10¹⁷ cm⁻³ or more and about 1.0×10²² cm⁻³ or less, for example. The resistivity of the semiconductor material decreases and the conductivity increases as the impurity doping amount increases. If the doping amount is about 1.0×10¹⁷ cm⁻³ or more, for example, the first electrode 2 can effectively function as an electrode. If the doping amount is about 1.0×10²² cm⁻³ or less, for example, a solid solubility limit of impurities in the silicon semiconductor material can prevent impurity precipitation. The refractive index of the first electrode 2 decreases as the doping amount increases. For example, the refractive index of the first electrode 2 is smaller than 3.

The refractive index of the semiconductor material is larger than the refractive index of the electro-optic material of the optical waveguide 1, regardless of whether it is doped with impurities or not. The refractive index of the semiconductor material that is not doped with impurities is, for example, about 3.4 for Si, about 5.5 for Ge, and about 3.3 for GaAs. The refractive index of the electro-optic material is, for example, about 2.3 for LiNbO₃, about 2.8 for LiTaO₃, about 2.5 for PLZT, about 2.1 for KTN, and about 2.6 for BaTiO₃, for example. The refractive index of the semiconductor material decreases when it is doped with impurities, but the refractive index of the doped semiconductor material is also larger than the refractive index of the electro-optic material.

Hereinafter, the range of the doping amount will be described in more detail. The reason why the upper limit of the doping amount is preferably, for example, about 1.0×10²² cm⁻³ is based on the solid solubility limit of impurities in the silicon semiconductor material. In the first electrode 2, when the doping amount exceeds the solid solubility limit of about 1.0×10²² cm⁻³, for example, the impurities precipitate, resulting in decreased reliability of the first electrode 2 and the optical modulator 10. On the other hand, the reason why the lower limit of the doping amount is preferably, for example, about 1.0×10¹⁷ cm⁻³ is as follows. The skin depth is used as an index to design the thickness and width of the electrode. When the thickness and width of the electrode are smaller than the skin depth, the resistance value increases. For this reason, it is preferable that the thickness and width of the electrode are larger than or equal to the skin depth. Considering the operation of an optical modulator that handles frequency signals of 1 GHz or higher, when the doping amount is about 1.0×10¹⁷ cm⁻³, the conductivity is about 1000 S/m and the skin depth is about 500 μm, for example. For example, considering that electrodes are formed from a silicon semiconductor material by microfabrication, the maximum thickness of the electrodes is about 500 μm, for example. Then, from the viewpoint of ensuring the performance as an electrode, the doping amount may be set to about 1.0×10¹⁷ cm⁻³ or more to obtain an electrode with the conductivity of about 1000 S/m or more, for example.

The first electrode 2 is, for example, a silicon single crystal substrate. For example, a silicon single crystal base material substrate to be the material of the first electrode 2 is pre-doped with the impurity. The first electrode 2 can be formed by disposing this base material substrate on another substrate, followed by patterning (etching, dicing or the like). The first electrode 2 may be an active layer of a silicon-on-insulator (SOI) substrate. In this case, the first electrode 2 can be formed by patterning (etching, dicing or the like) the active layer of the SOI substrate. Impurities may be further introduced into the first electrode 2 thus formed by thermal diffusion, ion implantation, or the like.

The first electrode 2 may be a semiconductor silicon layer formed on the substrate. For example, a silicon layer can be formed on the substrate by sputtering, vapor deposition, CVD, or the like. A semiconductor silicon layer as the first electrode 2 can be formed by introducing impurities into this silicon layer by thermal diffusion, ion implantation, or the like.

The second electrode 3 is spaced by a gap from the optical waveguide 1. In this example embodiment, the second electrode 3 is separated from the optical waveguide 1 in the stacking direction. The second electrode 3 is not in contact with the optical waveguide 1. The size of the gap between the second electrode 3 and the optical waveguide 1 is, for example, about 0.750 μm or more and about 1.675 μm or less. In this specification, the size of the gap between the second electrode 3 and the optical waveguide 1 means the shortest distance from the second electrode 3 to the optical waveguide 1. In the case of this example embodiment, the distance from the second electrode 3 to the optical waveguide 1 in the stacking direction is the shortest distance from the second electrode 3 to the optical waveguide 1.

The second electrode 3 is made of, for example, a metal material. That is, the second electrode 3 is a metal electrode. However, the second electrode 3 may be made of, for example, a semiconductor material. That is, the second electrode 3 may be a semiconductor electrode. Examples of the semiconductor material include those described as the semiconductor material used for the first electrode 2.

When the second electrode 3 is made of a metal material, the metal material mainly includes, for example, noble metal. The noble metal is, for example, Au (gold). Ag (silver), Pt (platinum) or the like may be used as the noble metal. The metal material may include trace amounts of other metal elements such as Cr and Ti. Copper, aluminum, an alloy thereof, or the like may be used as the metal material.

The second electrode 3 is used as a signal electrode and the first electrode 2 is used as a ground electrode. Conversely, the first electrode 2 may be used as the signal electrode and the second electrode 3 may be used as the ground electrode.

The first low dielectric constant layer 4 is provided in the gap between the first electrode 2 and the optical waveguide 1. In this example embodiment, the first low dielectric constant layer 4 is stacked on the first electrode 2, and the optical waveguide 1 is stacked on the first low dielectric constant layer 4. That is, the optical waveguide 1 is stacked indirectly on the first electrode 2 with the first low dielectric constant layer 4 interposed therebetween, and the first electrode 2 is not in contact with the optical waveguide 1. It is preferable that the first low dielectric constant layer 4 covers the entire surface of the optical waveguide 1 facing the first low dielectric constant layer 4.

The first low dielectric constant layer 4 has a refractive index smaller than that of the optical waveguide 1. For example, the refractive index of the first low dielectric constant layer 4 is smaller than the refractive index of the optical waveguide 1 by about 1% or more, for example. The refractive index of the optical waveguide 1 is smaller than the refractive index of the first electrode 2. The ratio of the refractive index of the optical waveguide 1 to the refractive index of the first low dielectric constant layer 4 is, for example, about 1.8 or more and about 2.5 or less, for example. In this case, light can be sufficiently confined within the optical waveguide 1. The ratio of the refractive index of the first electrode 2 to the refractive index of the first low dielectric constant layer 4 is, for example, about 1.5 or more and about 6.0 or less, for example. This makes it possible to prevent light from entering the first electrode 2 when light enters the optical waveguide 1 from an optical fiber.

The main component of the first low dielectric constant layer 4 is typically SiO₂. An oxide such as Al₂O₃, LaAlO₃, LaYO₃, ZnO, HfO₂, MgO, and Y₂O₃, or a polymer such as benzocyclobutene (BCB) and polyimide (PI) may be used as the main component of the first low dielectric constant layer 4.

The second low dielectric constant layer 5 is provided in the gap between the second electrode 3 and the optical waveguide 1. In this example embodiment, the second low dielectric constant layer 5 is stacked on the optical waveguide 1, and the second electrode 3 is stacked on the second low dielectric constant layer 5. That is, the optical waveguide 1 is stacked indirectly on the second electrode 3 with the second low dielectric constant layer 5 interposed therebetween, and the second electrode 3 is not in contact with the optical waveguide 1. It is preferable that the second low dielectric constant layer 5 covers the entire surface of the optical waveguide 1 facing the second low dielectric constant layer 5.

The second low dielectric constant layer 5 has a refractive index smaller than that of the optical waveguide 1. Examples of the main component of the second low dielectric constant layer 5 include those described above for the first low dielectric constant layer 4. The main component of the second low dielectric constant layer 5 may be the same as or different from the main component of the first low dielectric constant layer 4.

In the optical modulator 10 having such a configuration, the second electrode 3 can be stacked on the optical waveguide 1 and the first electrode 2 in the following manner, for example. First, the first low dielectric constant layer 4 is formed on the first electrode 2 by CVD, vapor deposition, sputtering or the like. A material substrate having an electro-optic effect is disposed on the first low dielectric constant layer 4 formed on the first electrode 2, and the material substrate is bonded to the first low dielectric constant layer 4. The material substrate is then subjected to lithography and etching to form the optical waveguide 1. Next, the second low dielectric constant layer 5 is formed on the optical waveguide 1 by CVD, vapor deposition, sputtering or the like. A metal layer is then formed on the second low dielectric constant layer 5 by sputtering, vapor deposition or the like. The metal layer thus formed is patterned by lithography and then etched to form the second electrode 3.

When a high frequency current flows through the first electrode 2 when using the optical modulator 10, a necessary thickness t2 of the first electrode 2 can be estimated based on the skin effect. The thickness t2 of the first electrode 2 corresponds to the length in the stacking direction. Formula (1) below is for calculating the skin depth of a conductor.

$$d = \sqrt{\frac{2 π}{ωμ}} = \sqrt{\frac{2}{ωμσ}} = \sqrt{\frac{1}{π f μσ}} \qquad ( 1 )$$

d: skin depth [m]
ρ: electrical resistivity of conductor [Ω·m]=1/σ
ω: angular frequency of alternating current [rad/s]=2πf
μ: magnetic permeability of conductor [H/m]
σ: conductivity of conductor [S/m]
f: frequency of alternating current [Hz]

From Formula (1) above, the thickness t2 required for the first electrode 2 can be determined. More specifically, by making the thickness t2 of the first electrode 2 larger than the skin depth calculated using Formula (1), the electrical resistance of the first electrode 2 can be reduced, thus reducing or preventing unnecessary electrical loss. It is preferable that the first electrode 2 has a higher conductivity. However, there is a solid solubility limit to the impurity doping amount, and when the doping amount approaches the solid solubility limit, the impurity clusters and becomes inactive as a carrier. Therefore, when the doping amount exceeds a certain amount, the conductivity of the first electrode 2 saturates. If the solid solubility limit of the doping amount is about 1.0×10²² cm⁻³, the conductivity of the first electrode 2 is about 1×10⁷ S/m and the skin depth of a 1 GHz electrical signal is about 5 μm, for example. However, the actual conductivity is expected to be about 1×10⁶ S/m, for example, which is lower by one order of magnitude. For this reason, assuming the operation of handling the electrical signal of about 0.5 GHz or more that has a band width, it is preferable that the thickness t2 of the first electrode 2 is about 25 μm or more, for example.

When using the optical modulator 10, the ratio Z/Z0 of a resistance Z of the optical modulator 10 to a termination resistance Z0 is preferably about 0.8 or more and about 1.2 or less, for example. This is because if the ratio Z/Z0 deviates from the condition of about 0.8 or more and about 1.2 or less, for example, a reflected wave of the electrical signal is generated at the terminal end of the electrode due to impedance mismatch. Therefore, it is preferable that the conditions of the optical modulator 10 are set so that the ratio Z/Z0 satisfies this condition. Specifically, it is preferable that the ratio t2/t4 of the thickness t2 of the first electrode 2 to the thickness t4 of the first low dielectric constant layer 4 is set so that the ratio Z/Z0 of the resistance Z of the optical modulator 10 to the termination resistance Z0 is about 0.8 or more and about 1.2 or less, for example. The thickness t4 of the first low dielectric constant layer 4 corresponds to the size of the gap between the first electrode 2 and the optical waveguide 1.

FIG. 2 is a graph showing the correlation between the ratio t2/t4 of the thickness t2 of the first electrode 2 to the thickness t4 of the first low dielectric constant layer 4 and the ratio Z/Z0 of the resistance Z of the optical modulator 10 to the termination resistance Z0. FIG. 2 shows, as an example, the relationship between the ratio t2/t4 and the ratio Z/Z0 when analysis is performed using a silicon semiconductor material as the first electrode 2, a metal material mainly composed of Au as the second electrode 3, SiO₂ as the low dielectric constant layers 4 and 5, and LiNbO₃ as the optical waveguide 1. In the analysis, the termination resistance Z0 is about 50Ω, a width w2 of the first electrode 2 is about 50 μm, a width w3 of the second electrode 3 is about 40 μm, a thickness t3 of the second electrode 3 is about 5.0 μm, the thickness t4 of the first low dielectric constant layer 4 is about 0.7 μm, a thickness t5 of the second low dielectric constant layer 5 is about 0.7 μm, a width w1 of the optical waveguide 1 is about 1.0 μm, and a thickness t1 of the optical waveguide 1 is about 1.3 μm, for example. Note that in this specification, the term “thickness” means the length in the stacking direction in the cross section of the optical modulator 10, and the term “width” means the length in the direction perpendicular to the stacking direction in the cross section of the optical modulator 10.

As shown in FIG. 2, in order for the ratio Z/Z0 to be about 0.8 or more and about 1.2 or less, the ratio t2/t4 of the thickness t2 of the first electrode 2 to the thickness t4 of the first low dielectric constant layer 4 is about 20.0 or more and about 44.0 or less, for example.

Referring again to FIG. 1, in this example embodiment, the first electrode 2 includes a semiconductor material. When a metal material is used as the material of the second electrode 3, it is preferable that the performance of the first electrode 2 as an electrode is equivalent to that of the second electrode 3, which is a metal electrode. The cross-sectional area of the first electrode 2 and the cross-sectional area of the second electrode 3 are preferably set such that the resistance value of the first electrode 2 substantially matches the resistance value of the second electrode 3. For example, the cross-sectional area of the first electrode 2 can be set to “(conductivity of second electrode 3/conductivity of first electrode 2)×cross-sectional area of second electrode 3”.

Specifically, when viewed in a cross section perpendicular to the extending direction of the optical waveguide 1, the area of the first electrode 2 is preferably larger than the area of the second electrode 3. When the second electrode 3 is made of a metal material, the second electrode 3 has a relatively small resistance value without increasing its cross-sectional area. On the other hand, the first electrode 2 is made of a semiconductor material having a lower conductivity than the metal material. Therefore, by making the cross-sectional area larger than that of the second electrode 3, the resistance value of the first electrode 2 can be reduced to the same level as the second electrode 3. The power consumption can thus be reduced or prevented.

Under the condition that the width w2 of the first electrode 2 is the same as the width w3 of the second electrode 3, in order for the resistance value of the first electrode 2, which is a semiconductor electrode, to match the resistance value of the second electrode 3, which is a metal electrode, the product of the conductivity and the thickness t2 of the first electrode 2 only needs to match the product of the conductivity and the thickness t3 of the second electrode 3. For example, when the metal material of the second electrode 3 is Au, the thickness t3 of the second electrode 3 is usually about 0.1 μm or more and about 2.0 μm or less, and the conductivity thereof is about 4.3×10⁷ S/m. On the other hand, the conductivity of the first electrode 2 is lower than that of the second electrode 3, and thus the thickness t2 of the first electrode 2 is larger than the thickness t3 of the second electrode 3. The conductivity of the first electrode 2 changes with the impurity doping amount.

For example, when the first electrode 2 is made of a silicon semiconductor material and the impurity doping amount is the upper limit of about 1.0×10²² cm⁻³, the conductivity of the first electrode 2 is about 1×10⁷ S/m. In this event, a value provided by dividing the conductivity of the second electrode 3 by the conductivity of the first electrode 2 is about 4.3, for example. The thickness t2 of the first electrode 2 can thus be set to about 4.3 times the thickness t3 of the second electrode 3. On the other hand, when the impurity doping amount is the lower limit of about 1.0×10¹⁷ cm⁻³, the conductivity of the first electrode 2 is about 1000×10⁴ S/m, for example. In this event, a value provided by dividing the conductivity of the second electrode 3 by the conductivity of the first electrode 2 is about 4.3×10³, for example. The thickness t2 of the first electrode 2 can thus be set to about 4.3×10³ times the thickness t3 of the second electrode 3, for example.

Therefore, when the first electrode 2 is made of a semiconductor material and the second electrode 3 is made of a metal material, the lower limit of the thickness t2 of the first electrode 2 can be set to about 4.3 times the lower limit of about 0.1 μm of the thickness t3 of the second electrode 3, for example. That is, the thickness t2 of the first electrode 2 can be set to about 0.43 μm or more, for example. On the other hand, the upper limit of the thickness t2 of the first electrode 2 can be set to about 4.3×10³ times the upper limit of about 2.0 μm of the thickness t3 of the second electrode 3, for example. That is, the thickness t2 of the first electrode 2 can be set to about 8600 μm (about 8.6 mm) or less, for example. However, when using a silicon semiconductor material for the first electrode 2, the thickness t2 of the first electrode 2 is preferably about 500 μm or less from the viewpoint of its workability, for example.

As described above, the second electrode 3 can also be formed of a semiconductor material. When the first electrode 2 and the second electrode 3 are both made of a semiconductor material, the area of the first electrode 2 is preferably the same as the area of the second electrode 3 when viewed in a cross section perpendicular to the extending direction of the optical waveguide 1.

The thickness t2 of the first electrode 2, which is the semiconductor electrode, and the thickness t4 of the low dielectric constant layer 4 can be measured by the following methods, for example. A first method is a measurement method using SEM observation. In this method, a sample is collected by cutting the optical modulator 10 using a focused ion beam (FIB). A cross section of the collected sample is imaged by SEM, and the thickness t2 of the first electrode 2 and the thickness t4 of the low dielectric constant layer 4 can be measured from the obtained image. Second method is an optical measurement method. In this method, the thickness t2 of the first electrode 2 and the thickness t4 of the low dielectric constant layer 4 can be directly measured by interference spectroscopy. Either method provides substantially the same measurement results.

When the second electrode 3 is a metal electrode, the thickness t3 of the second electrode 3 can be measured by the following two methods, for example. The first method is the measurement method using SEM observation described above. The second method is a measurement method using X-rays. In this method, attenuation by the second electrode 3 is determined by irradiating the second electrode 3 with X-rays and measuring the amount of transmitted X-rays. The thickness t3 of the second electrode 3 can be measured by back-calculating the attenuation thus determined. Either method provides substantially the same measurement results. When the second electrode 3 is a semiconductor electrode, the thickness t3 of the second electrode 3 can be measured by the method for measuring the thickness t2 of the first electrode 2 described above.

The doping amount of the first electrode 2 can be measured by epitaxial resistivity measurement, air gap CV measurement, mercury CV measurement, surface charge profiling, secondary ion mass spectrometry, spreading resistance measurement, or the like. Any of the methods provides substantially the same measurement results.

When viewed in a cross section perpendicular to the extending direction of the optical waveguide 1, the width w2 of the first electrode 2 on the optical waveguide 1 side is preferably larger than the width w1 of the optical waveguide 1. The width w2 of the first electrode 2 on the optical waveguide 1 side means the width of the surface of the first electrode 2 that is closest to the optical waveguide 1. In this example embodiment, the length of the surface of the first electrode 2 in contact with the first low dielectric constant layer 4 in the direction perpendicular to the stacking direction is the width w2. In this case, an electric field can be applied to the entire area of the optical waveguide 1.

### Advantageous Effects

In the optical modulator 10 according to this example embodiment, the first electrode 2, of the first electrode 2 and the second electrode 3 that apply an electric field to the optical waveguide 1, is made of a semiconductor material. The semiconductor material is typically doped with an impurity. To improve the function of the first electrode 2 as an electrode, the impurity doping amount needs to be increased. As the impurity doping amount increases, the conductivity of the first electrode 2 increases, but light absorptivity of the first electrode 2 also increases. The first electrode 2 made of the semiconductor material also has a refractive index larger than that of the optical waveguide 1. For this reason, when the first electrode 2 is in contact with the optical waveguide 1, light easily leaks from the optical waveguide 1 to the first electrode 2. Therefore, in this example embodiment, the first electrode 2 is spaced by a gap from the optical waveguide 1 so as not to be in contact with the optical waveguide 1, and the first low dielectric constant layer 4 having a refractive index smaller than that of the optical waveguide 1 is disposed in the gap between the first electrode 2 and the optical waveguide 1. This prevents the light passing through the optical waveguide 1 from leaking to the first electrode 2 side and from being absorbed by the first electrode 2. The optical modulator 10 according to this example embodiment can thus reduce or prevent the loss of light while realizing the application of a semiconductor material other than a metal material to the first electrode 2.

In a typical optical modulator, the effective refractive index of an electrical signal (modulated wave (GHz)) applied from an electrode to an optical waveguide is larger than the effective refractive index of a light wave (carrier wave (THz)) that passes through the optical waveguide. If the effective refractive index of the electrical signal is significantly different from the effective refractive index of the light wave, a difference in propagation speed between the light wave and the electrical signal increases, resulting in a decrease in modulation speed. In the optical modulator 10 according to this example embodiment, the first low dielectric constant layer 4 is disposed at least between the first electrode 2 and the optical waveguide 1. This makes it possible to adjust the cross-sectional area ratio of the first low dielectric constant layer 4 to the optical waveguide 1. By adjusting the cross-sectional area ratio of the first low dielectric constant layer 4 to the optical waveguide 1, the difference in effective refractive index between the electrical signal and the light wave can be reduced. This makes it possible to reduce the difference in propagation speed between the light wave and the electrical signal. The decrease in modulation speed can thus be reduced or prevented.

In this example embodiment, the second electrode 3 is spaced by a gap from the optical waveguide 1. In this case, the second electrode 3 is not in contact with the optical waveguide 1. The second low dielectric constant layer 5 having a lower refractive index than the optical waveguide 1 is also provided in the gap between the second electrode 3 and the optical waveguide 1. This prevents the light passing through the optical waveguide 1 from leaking to the second electrode 3 side and from being absorbed by the second electrode 3. The loss of light can thus be reduced or prevented.

The semiconductor material used for the first electrode 2 is, for example, a silicon semiconductor material in which Si is doped with an impurity. The first electrode 2 may be a silicon single crystal substrate, or may be a semiconductor silicon layer formed on the substrate. When the first electrode 2 is a silicon single crystal substrate, for example, the internal stress of the first electrode 2 can be reduced compared to a metal electrode formed by sputtering, vapor deposition or the like. This makes it possible to form a thick first electrode 2 while reducing or preventing the internal stress of the first electrode 2. By forming the thick first electrode 2, the resistance value of the first electrode 2 can be reduced, thus reducing or preventing power consumption. By reducing the internal stress of the first electrode 2, the occurrence of cracks due to the internal stress can also be reduced or prevented. This makes it possible to prevent failure or damage to the optical modulator 10.

The silicon semiconductor material is cheaper than a metal material using noble metal, for example. Therefore, using the silicon semiconductor material to form the first electrode 2 can reduce the cost of the optical modulator 10.

In this example embodiment, the first electrode 2 is stacked on the optical waveguide 1 and the second electrode 3 is stacked on the optical waveguide 1 on the opposite side of the first electrode 2. In this case, the optical waveguide 1 is provided between the first electrode 2 and the second electrode 3 in the stacking direction. Therefore, the electric field can be efficiently applied to the optical waveguide 1 by the first electrode 2 and the second electrode 3.

When the semiconductor material used for the first electrode 2 is a silicon semiconductor material, for example, the first low dielectric constant layer 4 of SiO₂ can be formed on the first electrode 2 by a thermal oxidation method. This achieves good close contact of the first low dielectric constant layer 4 with the first electrode 2, thus preventing foreign matter from entering the interface between the first electrode 2 and the first low dielectric constant layer 4. Therefore, electrical loss can be reduced or prevented at the interface between the first electrode 2 and the first low dielectric constant layer 4. The reliability and life of the optical modulator 10 can also be improved. This is because if foreign matter accumulates at the interface between the first electrode 2 and the first low dielectric constant layer 4 and the electric field concentrates on the accumulated foreign matter, the optical modulator 10 may be damaged.

The seepage depth of evanescent light in each of the low dielectric constant layers 4 and 5 can be estimated using the wavelength of the light (carrier wave) passing through the optical waveguide 1 as a guide. When each of the electrodes 2 and 3 is separated from the optical waveguide 1 by the wavelength of the carrier wave or more, the evanescent light can be prevented from coming into contact with each of the electrodes 2 and 3. Therefore, the size of the gap between the optical waveguide 1 and each of the electrodes 2 and 3, that is, the thicknesses t4 and t5 (lengths in the stacking direction) of the low dielectric constant layers 4 and 5 are preferably larger than or equal to the wavelength of light passing through the optical waveguide 1.

For example, as in this example embodiment, when the size of the gap between each of the electrodes 2 and 3 and the optical waveguide 1 is about 0.750 μm or more, for example, the thickness of each of the low dielectric constant layers 4 and 5 becomes larger than the seepage depth of the evanescent light, preventing the light passing through the optical waveguide 1 from leaking to each of the electrodes 2 and 3. As described above, the size of the gap between each of the electrodes 2 and 3 and the optical waveguide 1 may be about 1.675 μm or less, for example. When the size of the gap between each of the electrodes 2 and 3 and the optical waveguide 1 is about 1.675 μm or less, for example, the magnitude of the electric field to the optical waveguide 1 can be ensured without increasing the voltage applied between the first electrode 2 and the second electrode 3.

### Modification 1

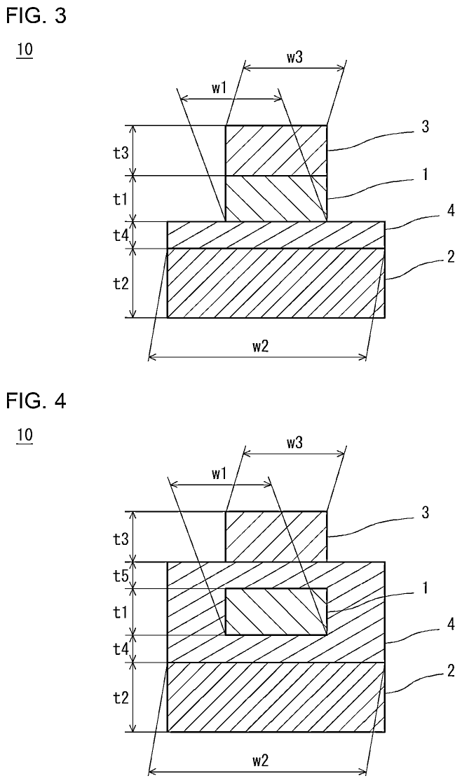

FIG. 3 shows modification 1 of the optical modulator 10 according to the first example embodiment. As shown in FIG. 3, the optical modulator 10 does not need to include the second low dielectric constant layer 5 (FIG. 1). That is, the second electrode 3 may be stacked directly on the optical waveguide 1 and may be in contact with the optical waveguide 1. In this case, again, the dimensional relationship between the first electrode 2, which is a semiconductor electrode, and the first low dielectric constant layer 4 can be determined as described above. For example, the ratio t2/t4 of the thickness t2 of the first electrode 2 to the thickness t4 of the first low dielectric constant layer 4 is preferably set such that the ratio Z/Z0 of the resistance Z of the optical modulator 10 to the termination resistance Z0 is about 0.8 or more and about 1.2 or less, for example.

### Modification 2

FIG. 4 shows modification 2 of the optical modulator 10 according to the first example embodiment. In this modification, as in the example shown in FIG. 3, the second low dielectric constant layer 5 (FIG. 1) is not provided in the optical modulator 10. However, in this modification, the first low dielectric constant layer 4 is provided so as to surround the optical waveguide 1 in a cross-sectional view of the optical modulator 10. The first low dielectric constant layer 4 is provided not only between the first electrode 2 and the optical waveguide 1 but also between the second electrode 3 and the optical waveguide 1. That is, the first electrode 2 and the second electrode 3 are not in contact with the optical waveguide 1, and the first low dielectric constant layer 4 is interposed between each of the first electrode 2 and the second electrode 3 and the optical waveguide 1. In this case, the first low dielectric constant layer 4 can also serve as the second low dielectric constant layer 5 (FIG. 1).

### Second Example Embodiment

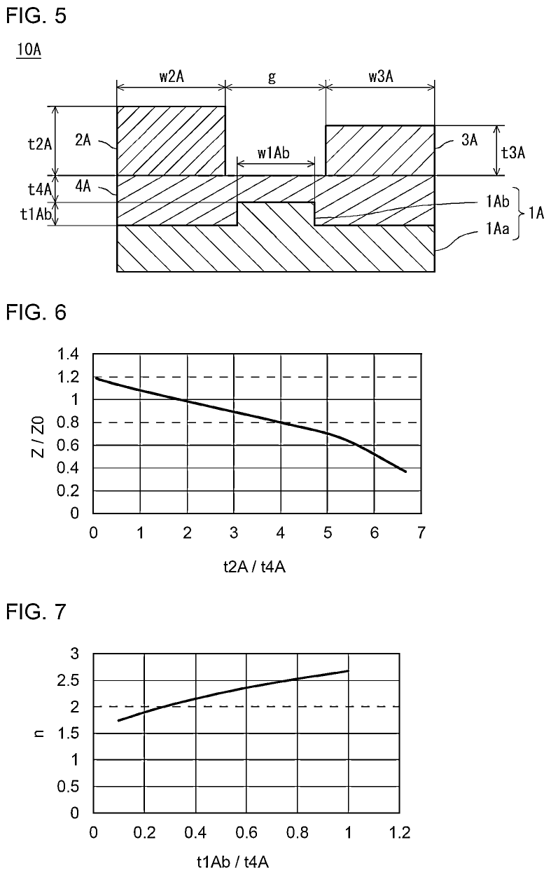

FIG. 5 is a cross-sectional view showing a schematic configuration of an optical modulator 10A according to a second example embodiment. The optical modulator 10A differs from the optical modulator 10 according to the first example embodiment in a configuration of an optical waveguide 1A and arrangement of a first electrode 2A and a second electrode 3A.

With reference to FIG. 5, the optical modulator 10A includes the optical waveguide 1A, the first electrode 2A, the second electrode 3A, and a first low dielectric constant layer 4A. The optical waveguide 1A includes a substrate 1Aa and a ridge 1Ab. The ridge 1Ab protrudes from the surface of the substrate 1Aa. The ridge 1Ab substantially functions as an optical waveguide. The first low dielectric constant layer 4A is stacked on the optical waveguide 1A. More specifically, the first low dielectric constant layer 4A is stacked on the substrate 1Aa and the ridge 1Ab.

The first electrode 2A and the second electrode 3A are stacked on the first low dielectric constant layer 4A. The first electrode 2A and the second electrode 3A are disposed in parallel with a gap therebetween. Specifically, the first electrode 2A and the second electrode 3A are disposed side by side in a direction substantially perpendicular to the stacking direction of the optical waveguide 1A and the first low dielectric constant layer 4A in a cross-sectional view of the optical modulator 10A. In the direction substantially perpendicular to the stacking direction, the first electrode 2A is disposed on one side of the ridge 1Ab, and the second electrode 3A is disposed on the other side of the ridge 1Ab. The first electrode 2A and the second electrode 3A can apply an electric field to the ridge 1Ab of the optical waveguide 1A by forming a potential difference therebetween.

The optical modulator 10A according to this example embodiment can also achieve the same effects as the optical modulator 10 according to the first example embodiment.

When using the optical modulator 10A, as described above, the ratio Z/Z0 of the resistance Z of the optical modulator 10A to the termination resistance Z0 is preferably about 0.8 or more and about 1.2 or less, for example. Therefore, the ratio t2A/t4A of a thickness t2A of the first electrode 2A to a thickness t4A of the first low dielectric constant layer 4A is preferably set so that the ratio Z/Z0 of the resistance Z of the optical modulator 10 to the termination resistance Z0 is about 0.8 or more and about 1.2 or less, for example. The thickness t4A of the first low dielectric constant layer 4A in this example embodiment is the thickness of the first low dielectric constant layer 4A at the position of the ridge 1Ab. The thickness t4A is the shortest distance from the interface between the ridge 1Ab and the first low dielectric constant layer 4A to the interface between the first low dielectric constant layer 4A and the first electrode 2A in the stacking direction of the ridge 1Ab, the first low dielectric constant layer 4A, and the electrodes 2A and 2B.

FIG. 6 is a graph showing the correlation between the ratio t2A/t4A of the thickness t2A of the first electrode 2A to the thickness t4A of the first low dielectric constant layer 4A and the ratio Z/Z0 of the resistance Z of the optical modulator 10A to the termination resistance Z0 according to the second example embodiment. FIG. 6 shows, as an example, the relationship between the ratio t2A/t4A and the ratio Z/Z0 when analysis is performed using a silicon semiconductor material as the first electrode 2A, a metal material mainly composed of Au as the second electrode 3A, SiO₂ as the first low dielectric constant layer 4A, and LiNbO₃ as the optical waveguide 1A. In the analysis, the termination resistance Z0 is about 50Ω, a width w2A of the first electrode 2A is about 50 μm, a width w3A of the second electrode 3A is about 21.5 μm, a thickness t3A of the second electrode 3A is about 16.6 μm, the thickness t4A of the first low dielectric constant layer 4A is about 8.3 μm, a width w1Ab of the ridge 1Ab is about 2.0 μm, a thickness t1Ab of the ridge 1Ab is about 1.0 pam, and a gap g between the first electrode 2A and the second electrode 3A is about 10 μm, for example.

As shown in FIG. 6, in order for the ratio Z/Z0 to be about 0.8 or more and about 1.2 or less, the ratio t2A/t4A of the thickness t2A of the first electrode 2A to the thickness t4A of the first low dielectric constant layer 4A is about 0.1 or more and about 4.0 or less, for example.

When using the optical modulator 10, an effective refractive index n is preferably a value that maximizes the modulation speed. Therefore, the ratio t1Ab/t4A of the thickness t1Ab of the optical waveguide 1A (ridge 1Ab) to the thickness t4A of the first low dielectric constant layer 4A is preferably set so that the effective refractive index n becomes the value that maximizes the modulation speed.

FIG. 7 is a graph showing the correlation between the ratio t1Ab/t4A of the thickness t1Ab of the optical waveguide 1A to the thickness t4A of the first low dielectric constant layer 4A and the effective refractive index n according to the second example embodiment. FIG. 7 shows, as an example, the relationship between the ratio t1Ab/t4A and the effective refractive index n when analysis is performed under the same conditions as in FIG. 6. However, the thickness t2A of the first electrode 2A is set to 16.6 μm.

When using LiNbO₃ as the optical waveguide 1A, the modulation speed can be maximized by setting the effective refractive index n to 2. As shown in FIG. 7, in order for the effective refractive index n to be 2, the ratio t1Ab/t4A of the thickness t1Ab of the optical waveguide 1A (ridge 1Ab) to the thickness t4A of the first low dielectric constant layer 4A is substantially about 0.28, for example.

### Third Example Embodiment

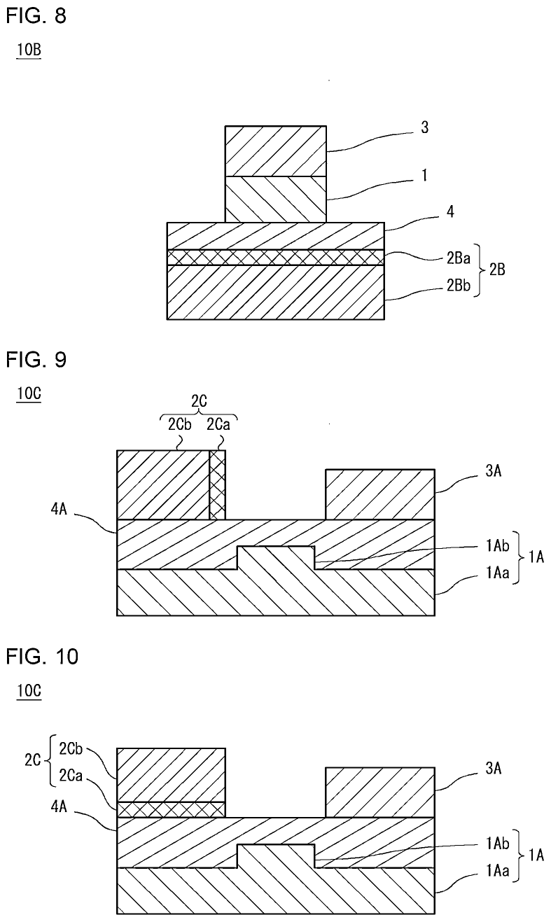

FIG. 8 is a cross-sectional view showing a schematic configuration of an optical modulator 10B according to a third example embodiment. The optical modulator 10B differs from the optical modulator 10 according to the first example embodiment in a configuration of a first electrode 2B.

With reference to FIG. 8, the first electrode 2B has a surface layer 2Ba on the optical waveguide 1 side and a remaining portion 2Bb. In the example of this example embodiment, the surface layer 2Ba of the first electrode 2B is disposed adjacent to the first low dielectric constant layer 4. The surface layer 2Ba is, for example, a portion within a range of about 10% of the length (thickness) of the first electrode 2B in the stacking direction of the first electrode 2B with respect to the optical waveguide 1, from the surface of the first electrode 2B on the optical waveguide 1 side. The remaining portion 2Bb means a portion of the first electrode 2B excluding the surface layer 2Ba. In the first electrode 2B, the concentration of impurities in the semiconductor material is higher in the surface layer 2Ba than in the remaining portion 2Bb. That is, in the first electrode 2B, the impurity concentration, that is, the dopant amount differs between the surface layer 2Ba and the remaining portion 2Bb. For example, the impurity concentration in the surface layer 2Ba is about 10% or more higher than the impurity concentration in the remaining portion 2Bb. Such an impurity concentration distribution in the first electrode 2B can be formed by a thermal diffusion method, an ion implantation method or the like.

In the first electrode 2B, the impurity concentration may change rapidly at the boundary between the surface layer 2Ba and the remaining portion 2Bb, or may gradually decrease with increasing distance away from the surface layer 2Ba in the stacking direction. The impurity concentration in the first electrode 2B can be measured by epitaxial resistivity measurement, air gap CV measurement, mercury CV measurement, surface charge profiling, secondary ion mass spectrometry, spreading resistance measurement, or the like. Any of the methods provides substantially the same measurement results. The difference in impurity concentration between the surface layer 2Ba and the remaining portion 2Bb can be confirmed by any of the measurement methods described above. Specifically, the above measurement method is implemented to obtain an impurity concentration profile in the depth direction from the surface of the first electrode 2B on the optical waveguide 1 side. From the impurity concentration profile thus obtained, an integration average of the impurity concentration of the surface layer 2Ba and an integration average of the impurity concentration of the remaining portion 2Bb are calculated as the impurity concentration of the surface layer 2Ba and the impurity concentration of the remaining portion 2Bb, respectively. Specifically, the integration average of the impurity concentration within the range of about 10% of the depth (thickness) of the first electrode 2B from the surface of the first electrode 2B on the optical waveguide 1 side is defined as the impurity concentration of the surface layer 2Ba. The integration average of the impurity concentration within the remaining range is defined as the impurity concentration of the remaining portion 2Bb. The impurity concentration of the surface layer 2Ba thus obtained is, for example, about 10% or more higher than the impurity concentration of the remaining portion 2Bb thus obtained.

In the first electrode 2B, a high-frequency signal propagates more through the surface layer 2Ba due to the skin effect. Therefore, it is preferable that the conductivity is higher near the surface layer 2Ba. In the optical modulator 10B according to this example embodiment, the surface layer 2Ba of the first electrode 2B on the optical waveguide 1 side is doped with impurities at a higher concentration than the remaining portion 2Bb of the first electrode 2. In this case, in the first electrode 2B, a region with high conductivity can be localized near the optical waveguide 1, and the skin effect can reduce or prevent attenuation of high-frequency signals.

### Fourth Example Embodiment

FIG. 9 is a cross-sectional view showing a schematic configuration of an optical modulator 10C according to a fourth example embodiment. The optical modulator 10C differs from the optical modulator 10A according to the second example embodiment in a configuration of a first electrode 2C.

With reference to FIG. 9, the first electrode 2C has a surface layer 2Ca on the ridge 1Ab side of the optical waveguide 1A and a remaining portion 2Cb. The surface layer 2Ca on the ridge 1Ab side is a surface layer of the first electrode 2C through which the electric field applied to the ridge 1Ab passes together with the second electrode 3A. In the example of this example embodiment, the surface layer 2Ca is a surface layer located on the ridge 1Ab side of the first electrode 2C that substantially functions as an optical waveguide in a direction (width direction) perpendicular to the stacking direction of the first electrode 2C with respect to the optical waveguide 1A. The surface layer 2Ca is, for example, a portion within a range of about 10% of the length of the first electrode 2C in the width direction from the surface located on the ridge 1Ab side in the width direction of the first electrode 2C. The remaining portion 2Cb means a portion of the first electrode 2C excluding the surface layer 2Ca. Similar to the first electrode 2B according to the third example embodiment described above, in the first electrode 2C, the concentration of impurities in the semiconductor material is higher in the surface layer 2Ca than in the remaining portion 2Cb. Therefore, the optical modulator 10C according to this example embodiment can also achieve the same effects as the optical modulator 10B according to the third example embodiment.

FIG. 10 shows a modification of the optical modulator 10C according to the fourth example embodiment. With reference to FIG. 10, the surface layer 2Ca may be a surface layer of the first electrode 2C located on the optical waveguide 1A side in the stacking direction of the first electrode 2C with respect to the optical waveguide 1. In this case, the surface layer 2Ca is, for example, a portion within a range of about 10% of the thickness of the first electrode 2C from the surface located on the optical waveguide 1A side in the stacking direction. This configuration can also achieve the same effects as the optical modulator 10B according to the third example embodiment.

Although the example embodiments according to the present disclosure have been described above, the present disclosure is not limited to the above example embodiments, and various changes can be made without departing from the spirit thereof.

For example, in the optical modulator 10 according to the first example embodiment, the first electrode 2 may include a convex portion. The convex portion is provided on the surface located on the optical waveguide 1 side in the stacking direction, and protrudes toward the optical waveguide 1. The convex portion comes into contact with the first low dielectric constant layer 4. In this case, the convex portion allows the electric field to be concentrated on the optical waveguide. Therefore, the voltage applied between the first electrode 2 and the second electrode 3 can be reduced, and the power consumption can be further reduced or prevented.

In the case where the first electrode 2 includes the convex portion, when viewed in a cross section perpendicular to the extending direction of the optical waveguide 1, the length of the convex portion in the direction perpendicular to the stacking direction may decrease as it approaches the optical waveguide 1. In this case, the side surface of the convex portion can be relatively gently continuous with the other portion of the surface of the first electrode 2 on the optical waveguide 1 side. This makes it possible to prevent electrical loss from occurring at the boundary between the convex portion and the other portion. The side surface of the convex portion may be inclined at a constant slope with respect to the surface, or the slope of the side surface may vary with respect to the surface.

The optical modulator 10 according to the first example embodiment may further include a thin metal film thinner than the first electrode 2. The thin metal film is provided on the surface of the first electrode 2 on the optical waveguide 1 side. The thin metal layer has high conductivity and low attenuation of high-frequency signals. The thin metal layer can be formed using a metal material that can be applied to the second electrode 3, for example. By providing the thin metal layer on the surface of the first electrode 2 on the optical waveguide 1 side, the resistance value can be reduced and signal attenuation can be reduced or prevented. The thin metal layer may be applied to each of the optical modulators 10A, 10B, and 10C according to the second to fourth example embodiments. In this case, the thin metal layer is provided on the surface of the first electrodes 2A, 2B, and 2C through which the electric field passes.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical modulator comprising:
an optical waveguide including a material having an electro-optic effect;
a first electrode including a semiconductor material and spaced by a gap from the optical waveguide;
a second electrode positioned to provide a potential difference with the first electrode and apply an electric field to the optical waveguide; and
a first low dielectric constant layer that has a refractive index smaller than a refractive index of the optical waveguide and is provided in the gap between the first electrode and the optical waveguide.

2. The optical modulator according to claim 1, further comprising:
a second low dielectric constant layer having a refractive index smaller than the refractive index of the optical waveguide; wherein
the second electrode is spaced by a gap from the optical waveguide; and
the second low dielectric constant layer is provided in the gap between the second electrode and the optical waveguide.

3. The optical modulator according to claim 1, wherein the first low dielectric constant layer surrounds the optical waveguide when viewed in a cross section perpendicular to an extending direction of the optical waveguide, and is provided between the optical waveguide and each of the first electrode and the second electrode.

4. The optical modulator according to claim 1, wherein
the first electrode is stacked on the optical waveguide; and
the second electrode is stacked on the optical waveguide on an opposite side of the first electrode.

5. The optical modulator according to claim 4, wherein a ratio of a thickness of the first electrode to a thickness of the first low dielectric constant layer is larger than or equal to about 20.0 and smaller than or equal to about 44.0.

6. The optical modulator according to claim 1, wherein
the optical waveguide includes a substrate and a ridge protruding from a surface of the substrate;
the first low dielectric constant layer is stacked on the substrate and the ridge; and
the first electrode and the second electrode are stacked on the first low dielectric constant layer and are parallel or substantially parallel with a gap between each other.

7. The optical modulator according to claim 6, wherein a ratio of a thickness of the first electrode to a thickness of the first low dielectric constant layer at the position of the ridge is larger than or equal to about 0.1 and smaller than or equal to about 4.0.

8. The optical modulator according to claim 1, wherein a size of the gap between the first electrode and the optical waveguide is larger than or equal to about 0.750 μm and smaller than or equal to about 1.675 μm.

9. The optical modulator according to claim 1, wherein the semiconductor material is a silicon semiconductor material in which silicon is doped with an impurity.

10. The optical modulator according to claim 9, wherein a concentration of the impurity in the first electrode is higher than or equal to about 1.0×10¹⁷ cm⁻³ and lower than or equal to about 1.0×10²² cm⁻³.

11. The optical modulator according to claim 9, wherein the first electrode is a silicon single crystal substrate.

12. The optical modulator according to claim 9, wherein a main component of the first low dielectric constant layer is SiO₂.

13. The optical modulator according to claim 1, wherein the first electrode has a refractive index smaller than 3.

14. The optical modulator according to claim 1, wherein a surface layer of the first electrode on the optical waveguide side is doped with an impurity at a higher concentration than other portions of the first electrode.

15. The optical modulator according to claim 1, wherein the material of the optical waveguide is lithium niobate, lithium tantalate, lead lanthanum zirconate titanate, potassium tantalate niobate, barium titanate or an electro-optic polymer.

16. The optical modulator according to claim 1, wherein the semiconductor material is germanium or gallium arsenide.

17. The optical modulator according to claim 9, wherein the impurity is a p-type impurity or an n-type impurity.

18. The optical modulator according to claim 1, wherein refractive index of the optical waveguide is 2.3, 2.8, 2.5, 2.1, or 2.6.

19. The optical modulator according to claim 1, wherein refractive index of the first low dielectric constant layer is about 1.5 or more and about 6.0 or less.

20. The optical modulator according to claim 1, wherein the material of the first low dielectric constant layer is Al₂O₃, LaAlO₃, LaYO₃, ZnO, HfO₂, MgO, Y₂O₃, benzocyclobutene, or polyimide.
